(19) United States
(12) Patent Application Publication
(10) Pub. No.: US 2011/0071880 A1
(43) Pub. Date: Mar. 24, 2011

(54) Location-based Emergency Response System and Method

(76) Inventor: Donald Spector, New York, NY (US)

(21) Appl. No.: 12/833,159

(22) Filed: Jul. 9, 2010

Related U.S. Application Data
(60) Provisional application No. 61/245,094, filed on Sep. 23, 2009.
(60) Provisional application No. 61/312,366, filed on Mar. 10, 2010.

(51) Int. Cl. G06Q 10/00

(52) U.S. Cl. 705/9

(57) ABSTRACT

A system and method for identification of a responder for responding to an emergency is disclosed. A server receives user data generally in the form of an electronic transmission wherein the user data includes at least an emergency type, user identity, and location of the emergency. A user profile is then retrieved from a user database based on the user identity. One or more responders are identified to dispatch to the emergency by searching a responder profile database that includes real-time location information based upon a criteria set including, the availability of the responder as indicated in the responder profile, and the proximity of the responder to the location of the emergency. The server electronically contacts one or more responders that meet the criteria set. An acceptance is received at the server from one or more of the responders. The server then dispatches one or more of the accepting responders to the location of the emergency. In certain embodiments, the server determines if a specialized responder is required based at least upon the user profile. In other embodiments, the transmission of the user data includes an emergency code and the server determines if a specialized responder is required based upon the emergency code.

### PRIORITY

The present U.S. Patent Application claims priority from two U.S. Provisional Patent Applications: the first U.S. Provisional Patent Application having Ser. No. 61/245,094 filed on Sep. 23, 2009 and entitled “Location Based Medical Referral System Based on an Individual's Needs and the Specialized Talents of Health Care Professionals” and the second provisional patent application having Ser. No. 61/312,366 filed on Mar. 10, 2010 and entitled “Customer Emergency Profile Information Added for GPS Response of Appropriate Parties”. Both U.S. Provisional Patent Applications are incorporated herein by reference in their entirety.

### TECHNICAL FIELD

The present invention relates to emergency response systems and methods and more particularly to emergency response systems that are location-based and wherein selection of a responder is based on both a user profile database and a responder profile database.

### BACKGROUND ART

It is known in the prior art to have an emergency response system. For example, a user dialing 911 obtains access to an emergency response system and speaks with an operator. The operator receives information from the user about the emergency and then determines if a responder is necessary to send and what type of responder to send to the emergency location. In addition, the operator asks the user a series of questions including the user's location (location of the emergency) and the user's name, age, and what has transpired (auto accident, robbery, fire etc.). The operator then causes a responder to be dispatched to the location of the emergency. The operator determines if the fire department should be summoned, the police department, or an ambulance. The operator contacts the dispatcher of one of these emergency response units (fire, police, medical) and the dispatcher will place a dispatch call. A responder that is proximate to the location of the emergency will acknowledge the dispatcher and the responder responds to the emergency.

Attempts have been made to automate emergency response systems. For example, U.S. Pat. No. 6,642,844 is directed to a direct dispatcherless automatic vehicle to vehicle and non-vehicle police/emergency medical notification system. The user contacts a dedicated emergency number indicating the type of emergency and also provides the location of the emergency using a wireless device such as a GPS equipped cell phone. The system uses a vehicle fleet management system that includes GPS which monitors the location of each vehicle in the fleet. The system selects the appropriate vehicle (police, ambulance etc.) that is closest to the emergency and informs the vehicle of the location of the emergency. The emergency personnel in the nearest vehicle can then acknowledge receipt of the message and that the vehicle will respond to the emergency. In the event that the emergency personnel does not acknowledge the emergency, the system will redirect the emergency communication to the next closest vehicle.

U.S. Patent application US 2007/0087726 is directed to a system and method for providing emergency notification services via enhanced directory assistance. The system stores in a database an emergency profile for a subscriber. The profile includes one or more instructions to be carried out in the case of an emergency. In this system, an operator receives an incoming communication and recalls the subscriber emergency profile and carries out the instructions. The user may carry a communication device such as a cell phone that can transmit the location of the user to the operator so that the operator may send emergency medical personnel to the user.

U.S. Patent application 2007/0167170 is directed to a system and method for determining location-enhanced presence information for a particular entity subscribed to a communication system. The patent application describes a system that allows a server to receive a location update for a particular entity and also an indication of a current activity status. Conditional rules may be applied based upon the combination of the current location and current activity status. The application provides several examples of how the conditional rules may be applied, but does not contemplate using them in an emergency situation.

### SUMMARY OF THE INVENTION

In a first embodiment of the invention there is provided a method for identification of a responder for responding to an emergency. The present methodology may be employed across various borders. For example, the system and methodology may be employed across an entire country or continent, so that emergency professionals that are traveling between states, countries or continents may be included within the search for identifying an appropriate responder that is proximate to an emergency location. Similarly, this system and methodology can be employed within a given region e.g. a town, city, state, country or worldwide. In order to implement such a system and methodology, licensing issues between the various jurisdictions would need to be adjusted to allow emergency professionals from one licensed region to perform emergency services in an unlicensed region.

In one embodiment, a server receives user data generally in the form of an electronic transmission wherein the user data includes at least an emergency type, user identity, and location of the emergency. A user profile is then retrieved from the user database based on the user identity. One or more responders are identified to dispatch to the emergency by searching a responder profile database that includes real-time location information based upon a criteria set including, the availability of the responder as indicated in the responder profile, and the proximity of the responder to the location of the emergency. Other criteria may be part of the criteria set. For example, a non-native English speaker may prefer a responder that can speak the user's native language. Thus, languages spoken may be one of the criteria for the criteria set. The server electronically contacts one or more responders that meet the criteria set. An acceptance is received at the server from one or more of the responders. The server then dispatches one or more of the accepting responders to the location of the emergency. In certain embodiments, the server determines if a specialized responder is required based at least upon the user profile. In other embodiments, the transmission of the user data includes an emergency code and the server determines if a specialized responder is required based upon the emergency code.

The transmission of the emergency request that contains the user data causes the server to restrict entries in the responder database to responders of the transmitted emergency type. For example, the responders may be police, fire, or medical responders. The emergency request may also contain an emergency level and if the level is high, the server will automatically send the closest responder to the emergency location. In addition, the server may further send a responder that meets the specialized requirements as defined by the criteria set.

If the emergency level that is transmitted is low, the user is directed to the location of a responder meeting the criteria set and no responder is dispatched to the location of the emergency.

The user profile may includes any specific medical conditions of the user. The server can use the specific medical condition either alone or in combination with other information transmitted by the user to determine if a specialized responder is necessary to dispatch to the location of the emergency. If a specialist is determined by the server to be necessary, the responder database is restricted to only responder profiles having the required specialty. Under certain circumstances, when selecting a responder to dispatch the server may restrict the responder database to only responder profiles within a predetermined proximity of the emergency location. The user profile may also include the user's medical insurance and the responder's profile may indicate the type of insurance that is accepted. The server can use under certain circumstances the user's medical insurance to determine an appropriate responder.

In general, the responder will transmit a location signal periodically to the server and the server will update the responder's profile with the location information. The responder like the user may have a global positioning receiver device, such as a GPS enabled cell phone that can provide the location information to the server. In embodiments of the invention the responder's profile contains an availability schedule for the responder. The server will not attempt to dispatch a responder outside of the schedule listed in the responder's profile. The availability schedule may be constrained by the emergency level. For example, a responder may respond to life or death events at anytime, but only respond to low level emergency events during business hours.

The methodology may be embodied in a computer program product. The computer program product including a computer readable storage medium having computer code thereon for execution by a computer for identification of a responder from a responder database for responding to an emergency. There may be separate computer program products for the user, the responders and for the server. The computer program for the user in one embodiment being an application that operates on a cellular telephone. Similarly, in embodiments of the invention the computer program for the responder may be an application that operates on a cellular telephone. The programs on the cellular telephones of the user and responders would preferably interact with a global positioning receiver within the cellular telephone housing.

Embodiments of the present invention may include a system for determining an appropriate responder to dispatch to an emergency location. The system includes a user profile database containing user profiles identifying each user and containing special medical condition information for the user. A responder profile database is also included that contains responder profiles at least identifying each responder, and a current location of the responder. The system further includes a decision engine including at least one processor for receiving an emergency request signal from a user wherein the emergency request signal includes indicia of user identity, user location, and emergency type. The decision engine selects one or more responders to dispatch to the user location based at least upon the emergency type and the responder's proximity to the user. The user's profile may also contain an indication of specific medical conditions. The responder's profile may further include an indication of the specialty of the responder. The decision engine may base its selection of one or more responders to dispatch to the user location based in part on the specialty of the responder as required by at least the medical condition in the user profile.

### BRIEF DESCRIPTION OF THE DRAWINGS

The foregoing features of the invention will be more readily understood by reference to the following detailed description, taken with reference to the accompanying drawings, in which:

FIG. 1 shows an embodiment of the invention for selecting and dispatching a responder to an emergency location based in part upon the proximity of the responder to the emergency;

FIG. 2 shows exemplary user and responder's profiles as used in an example based on FIG. 1;

FIG. 3A shows a flow chart for determining a responder based upon an emergency request transmission using a user profile database and a responder profile database;

FIG. 3B shows an alternative flow chart of an embodiment of the invention for determining a responder;

FIG. 4 shows a more detailed flow chart of the searching performed by a server based upon the received emergency request transmission;

FIG. 5 shows various and exemplary input variables for the emergency type, emergency level, and emergency code; and

FIG. 6 shows a server side embodiment of the invention.

### DETAILED DESCRIPTION OF SPECIFIC EMBODIMENTS

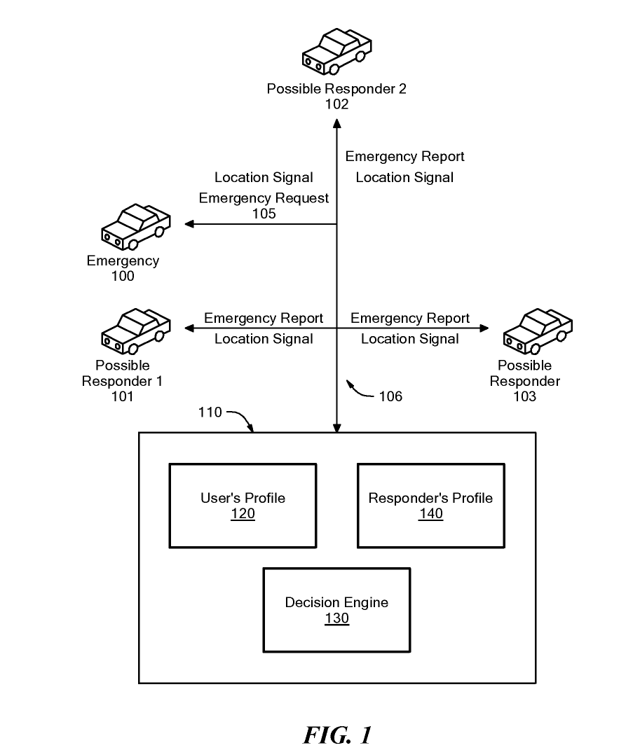

FIG. 1 shows an embodiment of the invention for selecting and dispatching a responder to an emergency location based in part upon the proximity of the responder to the emergency. The present system and methodology may be employed across regions and is not limited to a specific locality. For example, a responder visiting the New York area from England, may have the proper medical credentials and be the most proximate responder to an emergency location. Thus, the method and system are configured to identify such a responder without being restricted by licensing. The following system and methodology presumes changes to local, state, and national laws to allow responders that are proximate to an emergency that are outside of their licensed jurisdiction to be permitted to respond. Thus, changes to the laws with respect to reciprocity between jurisdictions would be necessary. Although applicable to responders operating outside of their licensed jurisdiction, the present system and method may in certain embodiments restrict the selection of responders based upon licensing and credentials. Similarly, the present method and system can be employed in a single town, city, state or country.

In such a system, a user of the system has an associated communications device. The communications device may be wireless, for example, a cellular telephone, a telemetric system in the user's car, or a pager. The user transmits an emergency request signal with the wireless communications device to a central server. In its simplest form, the emergency request signal includes a user identifier, the location of the user/emergency, and an emergency code. In one embodiment, the emergency code may be a selection between two possible options. The first option may be a signal indicating that the emergency is related to a medical condition that the user has as identified in the user's profile. The second option may be an indication that some other emergency has occurred that requires assistance. In such an embodiment, the wireless communication device could be a wireless transmitter that contains a global positioning satellite (GPS) receiver, a processor with associated memory and two buttons that the user can press in order to indicate that the emergency is of the first code type or the second code type. In such a system, the emergency type would be limited to medical emergencies. In other embodiments, the wireless communication device may be more sophisticated with more than two possible entries and the emergency request signal may contain additional information such as an emergency type, an emergency level, and an emergency code that specifies what the emergency is.

In other embodiments, the communication device may simply be a land-line telephone. In such a system, the user would call a specific number that connects to the server. The server would include a speech generation module that automates a series of questions that the user may respond to. The questions would include, at least the name of the user, the location of the user, the emergency type, a description of the emergency that could be used to code the emergency. The server would include a speech recognition unit for recognizing the answers to the questions which form the emergency request and could process the answers as an emergency request signal.

The communication device may transmit the emergency request signal over a wireless data information network, such as a telecommunication network (e.g. 3G, UMTS, CDMA2000, WiMAX, 4G, IMT advanced etc.) that provides for wireless Internet connectivity. If the wireless communication device is a data-enabled cellular phone, the cellular phone will include a client-side user application that in response to a user indicating that there is an emergency, the application accesses data from the cellular phone's GPS receiver regarding the location of the cellular phone and transmits the location information along with the other parameters (user-identifier, emergency type, and emergency code) of the emergency request signal over the telecommunications network to a server.

The server has access to a user profile database and a responder's profile database. The server also includes a decision engine that determines the one or more appropriate responders to dispatch to the emergency location based upon a plurality of factors such as, proximity, specialty, availability, emergency level, and emergency type for example. Other factors may also be used to determine an appropriate responder. For example, languages spoken or nationality may be criteria that are used to select an appropriate responder. Similarly, years of experience may be a criteria as might credentials and certifications. The criteria provided herein should not be seen as limiting, but only as exemplary. The proximity of the available responders is capable of being determined since, the responders are also equipped with communication devices. Although the communication devices used by the responders and the users need not be the same type of device. Typically, responders would have wireless communications devices. These wireless communication devices execute a client-side responder application that periodically transmits updated location information to the server including an identifier for the responder. The responder need not interact with the wireless communication device in order for this periodic transmission to occur. The location information is parsed from the transmission and the responder's profile in the responder database is updated with the current location information. The system may be configured so that if the server does not receive a current location for a responder within a predetermined period of time that the server flags the responder's profile entry and the responder's profile is excluded from being used by the decision engine in choosing a responder to dispatch to the emergency. The responder profile contains information about the responder, such as who the responder is, a present location, availability, and specialty.

As shown in the example of FIG. 1, there are three responders that are each traveling in vehicles 101, 102, 103. Although vehicles are shown, the responder need not be in a vehicle and may be on foot or stationary. A user 100 of the system, signals through use of his wireless communications device that an emergency has occurred by transmitting user data 105. As used herein, the term emergency implies that the user is requesting help and does not imply the severity of the emergency or whether the emergency is medical, police, or fire. The request 105 is transmitted through a network 106 that may be wireless, wired or a combination of both. The request 105 eventually reaches the server 110. The server 110 receives the request and parses a user identifier, such as a profile number or name, etc. and retrieves the user's profile from the user profile database 120. The user's profile includes the user's name and also any medical conditions that the user may have. These conditions may dictate that a specialist that can treat the medical condition should be considered by a decision engine 130 when dispatching one or more responders.

The decision engine 130 also accesses and searches the responder profile database 140 for appropriate responders. In one embodiment, the emergency request signal 105 includes a user identifier, GPS location information, and a selection of one of two code buttons. In such an embodiment, the decision engine 130 restricts the responder's profile database 140 to medical personnel and based upon the button selected (one of two buttons) either identifies a specialist to dispatch to the location of the emergency, since the selected code button indicates that the emergency is related to a medical condition as identified in the user's profile or the decision engine identifies the closest medical responder to dispatch to the location of the emergency.

In other embodiments of the invention, the decision engine 130 restricts the number of entrees in the responder database based upon a criteria set and logic. The criteria set and logic uses information from the user data received in the emergency request signal, along with information contained within the user's profile from the user's profile database. For example, the emergency type as received in the emergency request signal may indicate that the emergency is a fire emergency and therefore the decision engine would search the responder's database and limit further searches only to responders that are fire personnel. Thus, fire emergency would be part of the criteria set. In another example, the user's profile may indicate that the user has heart condition, therefore it would be preferable if the responder was a cardiologist or cardio pulmonary surgeon in the event that the emergency code indicates that the user is having a heart attack. The decision engine 130 would perform a search requiring that the medical professional have some cardiac expertise and restrict any subsequent searches to the results of the search. Thus, cardiac expertise would be part of the criteria set.

The decision engine 130 may restrict the search results based upon the proximity of the responder to the user. Thus, for example, within 5 miles may be part of the criteria set. Similarly, the criteria set may be based upon the emergency level and the context of the emergency (e.g. emergency codes for: heart attack, head trauma, burn etc.). The emergency request signal may also include an indicator of the severity of the emergency. For example, one simple coding scheme may require the user to rank the emergency from 1-3 wherein 1 is a high emergency level that is a life or death event, 2 is an intermediate emergency level that is less time critical, but requires a responder, and 3 is a low level emergency wherein the user can travel to the responder.

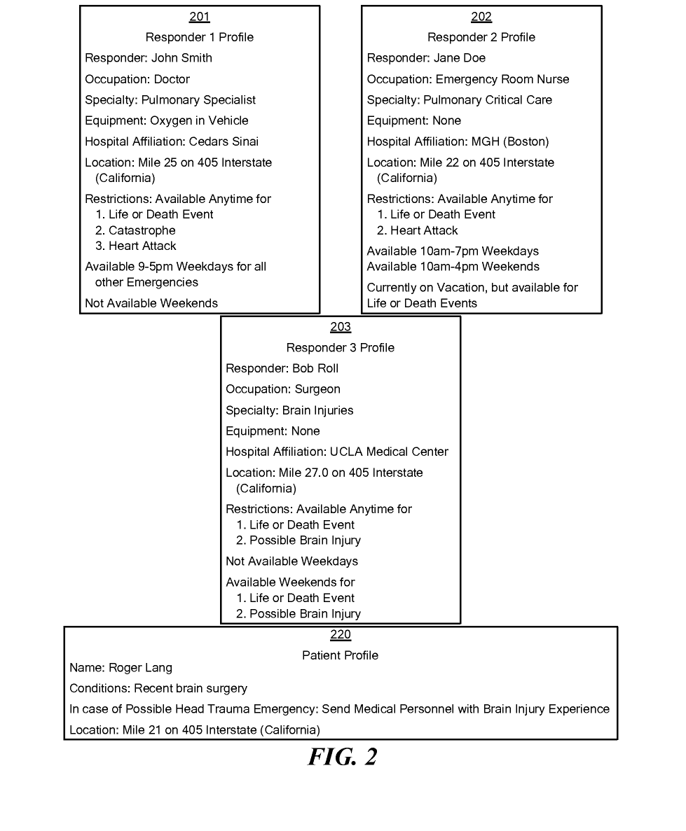

FIG. 2 shows exemplary user and responder's profiles as used in an example based on FIG. 1. The decision engine 130 of FIG. 1 retrieves the user profile from the user profile database 120 and then also accesses and searches the responder profile database 140. As shown in the user profile 220, the exemplary user (i.e. the patient) is Roger Lang who has had recent brain surgery and additionally is located at mile 21 of the 405 Interstate. The decision engine logic 130 will determine whether or not a brain specialist needs to be sent to the emergency location based upon the criteria set.

If the user indicates that the emergency type is a medical emergency, and the emergency code indicates that there has been a car crash, the decision engine 130 would search for any brain specialists proximate to the user because there is a strong likelihood of head trauma. As shown in FIG. 2, Responder 3 (203) would be the ideal responder, since the responder is a surgeon that specialize in brain injures. Thus, the decision logic would include possible combinations of criteria sets for which a particular specialist, particular equipment, or particular drug would be required. This logic may be a complex set of entries through which the decision engine 130 can determine the qualification of the proper responder.

In another example, the user may be a 70 year old, that has impaired breathing, and has indicated to the server through the wireless transmission device that the user is unable to breath. Although a particular specialist may not be necessary, the decision engine 130 would determine that oxygen should be available for the patient and would dispatch a proximate responder that had an oxygen tank available. For example in FIG. 2, Responder 1 (201) has oxygen in his car and would be selected as the appropriate responder to dispatch to the emergency location.

In embodiments of the invention, the wireless device may be part of a telematics system built into a user's automobile, wherein sensors on and within the car upon impact would trigger the telematics system to send the emergency request signal. In the event of a car accident, the wireless communication device transmits the user emergency request to the server. The telematics system of the automobile sends this emergency request and includes the driver's identifier. In certain embodiments of the invention, the telematics system within the car may also send an identifier for any passengers in the car. The telemetric system of the vehicle may inquire upon entry into the vehicle who is present within the vehicle. This can be done through a voice activated query system, through radio transmission tags/cards carried by each passenger, or by a key fob that electronically communicates with the telemetric system. In addition to user identification, the location of the emergency is transmitted. This information can be obtained through a GPS receiver that is part of the navigation system of the automobile. Additionally, the telematics system may transmit that the emergency is a medical/fire emergency, and additionally provide an emergency code. For example, the code may indicate that there has been a car crash. The decision engine can then access the user profile and based upon the received information along with the entries in the user profile, the decision engine would know that this emergency was a life or death emergency, that the emergency was a car accident, and as a result the decision engine would determine that any nearby medical and fire responder can be dispatched.

The decision engine logic 130 may also include priorities of different elements within the criteria set. For example, if the emergency is categorized as high, the decision logic may automatically dispatch the closest responder thereby prioritizing proximity and subjugating specialty. As shown in FIG. 2, responder 2 (202) is the closest responder and is within 1 mile of the emergency location (i.e. mile 22 of the 405 interstate for the responder and mile 21 of the 405 interstate for the emergency location). Additionally in the same example, the decision engine logic 130 may determine that a pulmonary specialist should be dispatched as well and thus, the decision logic 130 would prefer the responder's specialty over the proximity of the responder. The decision engine 130 would then first determine all possible pulmonary specialist responders and then identify the closest qualified responder to dispatch. For example, in FIG. 2 responder 1 (201) is a pulmonary specialist, but is not the closest responder. However, since specialty is preferred over proximity, the server dispatches responder 1 to the emergency location. Thus, in this example, at least two responders would be dispatched to the emergency location. The decision engine logic 130 finding each responder by prioritizing a different one of the criteria elements.

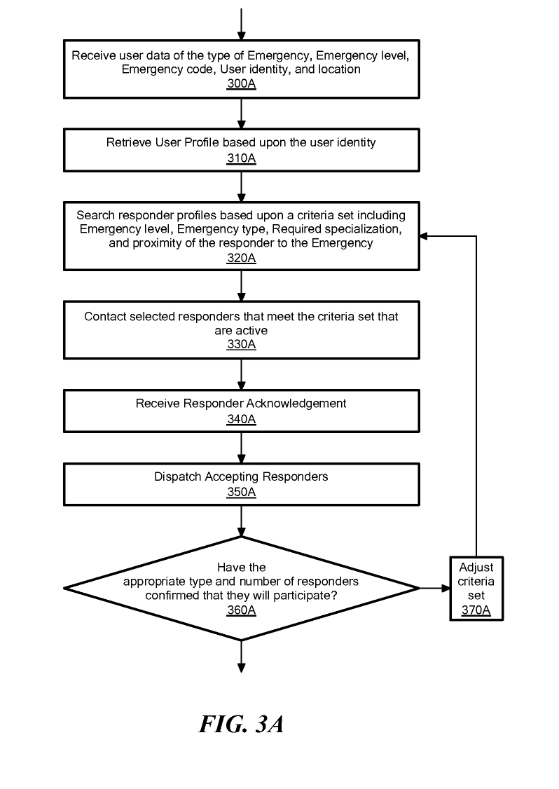

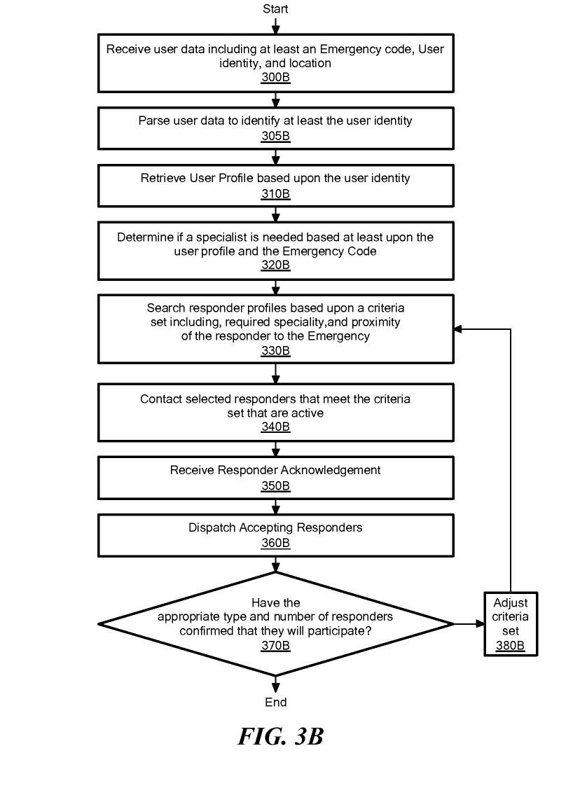

FIG. 3A is a flow chart of the methodology used in one embodiment of the invention. This flow chart is directed to a system where the user has a communication device that provides a reduced number of emergency codes (e.g. 2, 3) and is limited to medical emergencies. In such a system, the user may have a wireless communication device that includes two buttons that indicate that a types of possible medical emergency. As expressed above, one emergency type may be indicative of a known medical condition that is stored in the user's profile and the second emergency type may indicate that there is some other medical emergency. The communication device in this embodiment would include a GPS receiver along with a processor and associated memory. The memory would include the user identifier and the processor could form and then transmit over a communication network an emergency request signal.

First, the server receives user data including at least the user identity, the location of the emergency and an emergency code 300A. The server parses the received data and identifies at least the user identifier. The server may also parse and store the location of the emergency and the emergency code. The server access the user profile database and searches for the user's profile based upon the user identity that was parsed from the emergency request signal 310A. The server, using decision logic determines if a specialist is needed based upon the user's profile and also the transmitted emergency code 320A. For example, if the emergency code indicates that the emergency is related to a medical condition in the user's profile, the decision logic will locate within the user's profile what the medical condition is. For example, the medical condition may be that the user has weak lungs and trouble breathing. Based upon this information, the decision logic would include within the criteria set for responders that the responder should be a pulmonary specialist. Additionally, the decision logic may indicate that one or more the responders should have oxygen available. After determining whether or not a responder needs a specialty, the server searches the responder profiles based upon the formed criteria set that includes the required specialty and the proximity to the emergency. The server may have a default proximity for searching, for example a 5 mile radius, or the server may default to locating the closest responder that meets the other criteria of the criteria set. For example, the server may search for the closest pulmonary specialist. However, the server may include logic that limits the maximum distance that the responder with a specialty can be from the emergency location. For example, an emergency may occur at a location and the first pulmonary specialist may be located 100 miles away from the emergency location. The server may not attempt to dispatch the specialist, but rather dispatch the closest responder. In other circumstances, the server may have a default provision that if the distance between the specialist and the emergency location is greater than 25 miles and less than 100 miles, the server will default to sending the closest responder in addition to requesting the specialist. After one or more responders are identified that meet the criteria set for the decision engine, the server will communicate with the responders 330A. The server contacts the selected responders so that they can confirm that they are available to be dispatched. The server waits an appropriate amount of time (e.g. 30 sec, 1 min., 2 min. etc.) for responses. The server receives acknowledgements from the responders 340A. If no responder responds to the server, the server will expand the search criteria set. If one or more responders acknowledges the request to be dispatched, the server will send a transmission to the one or more servers indicating that they have been dispatched to the emergency location 350A. The server then queries whether an appropriate type and number of responders have been dispatched 360A. If the answer is no, the server will adjust the criteria set 370A so that the set of possible results is more expansive and will repeat the search process and contacting of the responders until the appropriate responders have confirmed that they agree to be dispatched to the emergency location. If the proper number and type of responders has been dispatched, the method ends.

FIG. 3B shows an alternative flow chart of an embodiment of the invention performed at a server that uses both a user profile database and a responder profile database. The server first receives an emergency request transmission 300B. The emergency request transmission is generated by a communication device of the user. In contrast to the emergency request transmission sent to the server in FIG. 3A, the emergency request transmission of FIG. 3B includes a user identifier, emergency type, emergency level, and an emergency code. Thus, in this embodiment of the invention the user identifies the severity of the emergency. One concern with allowing the user to determine the severity of the emergency is that users may vary in the way in which they classify an emergency. In order to avoid the problem of having a user repeatedly categorize an emergency as “life or death” when in actuality the emergency was a low priority emergency, the system can be reviewed and user's that abuse the system can be removed from the system. Additionally, by including an emergency code that provides additional detail about the emergency, the server is provided with two pieces of information that are indicative of the severity of the emergency. For example, the user may categorize the emergency level as low, but provide the emergency code for a heart attack. Under such circumstances, the server would default to assuming that the emergency level is high (life and death) given that a heart attack qualifies as a “life or death” event. In contrast, a user may indicate that an event is a high emergency level and then indicate in the emergency code that the emergency is a “cold.” The decision engine of the server would lower the emergency level to low given the information provided in the emergency request transmission.

Next, the server parses the transmission and identifies the user identifier 305B. Based on the user identifier, the server searches the user profile database and retrieves the user profile that corresponds with the user identifier 310B. The server then uses the decision engine logic to search the responder profile database for one or more appropriate responders to dispatch to the emergency location 320B. The decision engine logic defines a criteria set. Based upon the received emergency request transmission, the server identifies the emergency type (fire, medical, police), the emergency level (1=high to 3=low), the emergency code (heart attack, car crash, unconsciousness etc.) and adds these to the criteria set. The decision engine logic also locates within the user's profile the field that indicates any current medical conditions and adds the medical conditions to the criteria set. First, the decision engine logic identifies the emergency type and searches the responder database limiting the responders to the particular type of emergency (fire, medical, police). The decision engine then prioritizes the criteria. If the emergency level is high, the decision engine prioritizes proximity in order to first send the closest responder to the emergency location. The decision engine will also identify the user's current medical conditions and also the emergency code to determine if a specialist is required. The decision engine logic may require a specialist if certain emergency codes are selected. For example, an emergency code representing a heart attack would trigger the requirement that at least one of the responders is trained in critical cardiac care or is a cardiologist or cardiac surgeon. Similarly, if the user's current medical condition indicates that the user has severe brain trauma, a doctor specializing in the treatment of brain trauma may be required. Additionally, the emergency level, the emergency code and the prior medical conditions in combination may trigger that a specialist is required. For example, a specialist may not be required if the emergency level is low, the user has recently had spinal surgery, but the emergency code is related to a minor hand injury. In contrast, a back specialist may be required if the user has had recent back surgery and there has been a car accident, if the emergency level is medium or high. It should be recognized, that the coding scheme provided herein is for exemplary purposes and that other coding schemes and logic defining responder characteristics may be substituted without deviating from the intent of the invention.

The decision logic the searches the responder profile database for responders that meet the criteria set. 330B If there are a large number of responders that qualify based upon specialty or emergency level, the server will use proximity to the emergency location to restrict the number of responders to contact. The server may iteratively search for responders that are proximate to the emergency location. For example, the system may first limit the responders to a one mile radius from the emergency location. The server would then expand the search to a larger area if there are no qualifying specialists within the one mile proximity. Additionally, the decision logic may make determinations about how quickly a responder may be able to travel to the emergency location. For instance, the decision logic may recognize that a first responder is located on a highway, but further away from the emergency location than a second responder that is located on a suburban street, and determine that the first responder will reach the emergency location before the second responder because the first responder will be able to travel at highway speeds. In such an embodiment, the decision logic of the server would include map and road information with designations of the road types and would include a computer program as are known in the art for calculating expected arrival times.

The server will contact the one or more responders that meet the criteria set and are active. 340B The server during searching for responders will check to see if the responder is presently active. The responder is provided with the ability to set a schedule of available times for responding to emergencies and also the level of emergency that the responder is interested in responding to. Additionally, the responder can indicate whether the responder is mobile or stationary. If the responder is available, but stationary, for example, the responder is a doctor and has patient hours between 9 am and 5 pm at her office, the server may only use the responder in the case of a low priority emergency and may direct the user to the location (e.g. Doctor's Office) of the responder.

The server waits for an acknowledgement from the one or more contacted responders. 350B The responders may use a wireless telecommunications device, such as, a cellular telephone that is capable of running a responder client-based program. The program may become active and provide an alarm (visual, auditory) when a responder is being requested. The responder acknowledges the request if the responder is available to be dispatched. The responder may acknowledge the request through the press of a button or an oral command if the responder's communication device includes a speech recognition system. The server receives the acknowledgement and sends the dispatch request to one or more of the acknowledging responders. 360B The server may be configured to limit the number of responders that are sent to a particularly emergency location. For example, if the four closest responders that are requested each acknowledge the request, the server may choose to only dispatch a single responder and that responder may be chosen based upon proximity. The server determines if the proper number of responders has been dispatched. 370B If so, the process ends. If not, the criteria set is adjusted. 380B For example, if a cardiologist is requested within 20 miles of the emergency location, the search may be expanded to 30 miles or the category of specialist may be broadened (e.g. cardio-pulmonary doctor, cardiac nurse).

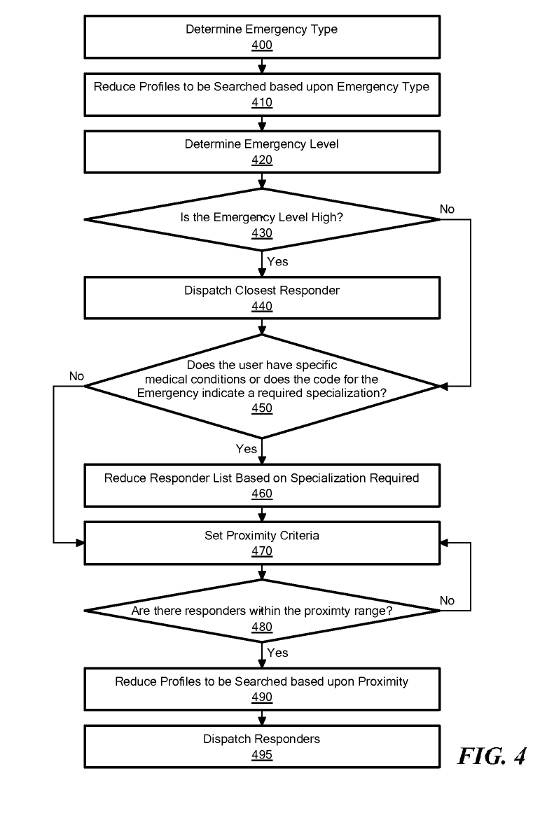

FIG. 4 shows a more detailed flow chart of FIG. 3B for selecting a responder to send to an emergency location. The server receives the user data in the emergency request transmission and parses the data. The server identifies the emergency type (fire, medical, police). 400 Based upon the emergency type the server searches the responder profile database and reduces the set of potential responders. 410 The server may use multiple parameters for this search. For example, the search may be based upon a maximum distance and emergency type (e.g. 150 miles and fire).

The emergency level is parsed and identified from the user data. 420 The server using the decision logic checks to see if the emergency level is high. 430 If the emergency level is high, the server defaults to searching for the closest responder to send to the emergency location of the appropriate emergency type. 440 The server then makes a request, receives an acknowledgement, and then dispatches the closest responder that acknowledges the request. The server then inquires if a specialist is necessary. 450 The decision logic retrieves the user's profile based upon a user identifier from the user data and parses the user's profile to identify if the user has any specific medical conditions that would warrant the need for a specialist. The decision logic also parses from the user data the emergency code and identifies what the emergency is. The decision logic can then check a predefined relational database or look-up table to see if the medical condition and emergency code combination requires a specialist and what type of specialist should be requested. The result of this search may be that there are a plurality of specialist that meet the criteria, although the specialist will have a preferred order (e.g. ENT surgeon, ENT doctor, ENT nurse etc.).

The responder database is searched or a past search result is further searched to reduce the responder list based upon the required specialization. 460 If no specialization is required, the decision logic will continue, and a proximity criteria will be set. 470 The proximity criteria may be used at multiple points in this flow chart and is shown at this location in the flowchart as an example and not as a limitation. The decision logic may begin with a predefined proximity of 5 miles. The decision logic performs the search and if there are responders that meet the criteria, the server contacts the responders to confirm if they are available and upon confirmation, the server sends a dispatch request to the responder.

If one or more responders is required to have a specialty, specific equipment, or specific medications/drugs, the server searches either the responder database list or the results of a previous search to identify one or more appropriate responders. The proximity criteria is set and the number of responders is further reduced. The decision logic of the server checks to see if the appropriate number and type of responders are available within the preset range. 480 For example, the decision logic may determine based upon a search of a predefined look-up table or relational database that both a cardiac specialist and a pulmonary specialist should be dispatched, however given the proximity criteria only one of the two are available. Thus, the server would adjust the proximity criteria, increasing the proximity in order to capture a responder that has the missing specialty. In certain applications of the invention, the decision logic may be programmed so that the search requires that a plurality of specialist responders are located. For example, the decision logic of the server may indicate that a minimum of two specialists are required. By requiring a plurality of specialists, the system allows for the chance that an available specialist may not acknowledge a request transmitted by the server and thus, at least one specialist will be available to be dispatched.

The server reduces the number of responder profiles based upon the proximity limitation and then sends a request to each of the responders that have met the criteria set. 490 Based upon the received acknowledgement(s), the server will then send a dispatch request to one or more of the acknowledging responders. 495 It should be understood that even though a responder acknowledges a request to be dispatched, the responder may not actually be dispatched. For example, five responders may acknowledge a request to be dispatched and the server may choose to dispatch the closest among the five responders to the emergency location. When a responder is dispatched to the location of the emergency, the responder may be provided with an address of the emergency, latitude and longitude coordinates or directions. The directions can be determined by the server using known navigation techniques and based upon the location information as provided by the user in the emergency request transmission and found in the responders profile.

In certain embodiments of the invention, information about insurance coverage may be part of the user's profile and that for the responder. The server may determine if the user has appropriate insurance that is accepted by a responder and may decide to select a responder based upon an appropriate insurance match. This insurance matching would be particularly useful when the emergency level is low and the user is being directed to a responder's office.

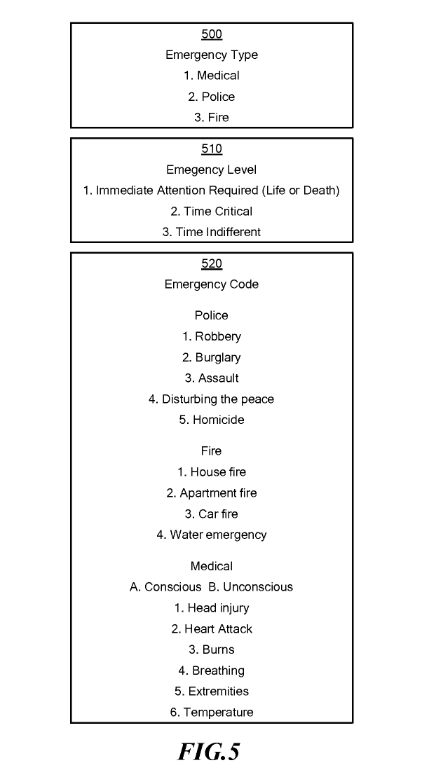

FIG. 5 shows various and exemplary input variables for the emergency type 500, emergency level 510, and emergency code 520. As shown, the emergency type list three possible entries (medical, police, and fire). The user may enter the emergency type into a computer application by typing the words, through user selection, or through entry of a number. Similarly, this could be achieved through a speech interface, wherein the user would be prompted for the emergency type and allowed to choose one of the three entries.

FIG. 5 also includes an indication of the emergency level. 510 As indicated in this example, the emergency level could also have three possible inputs. As shown, the inputs are high, medium, and low wherein high represents a life or death event, medium represents a request for a responder however the response is not as time critical as for a life or death event, and low where the emergency does not require a responder to come to the emergency location rather the user can be directed to the location of a responder. It should be recognized that if the system receives a low emergency level indication in the emergency request transmission, the system will still identify an appropriate responder, and request acknowledgement from the responder, however the responder will be selected from a group of stationary responders. For example, doctors that have an office at a specific address would be considered a stationary responder. The server would calculate the directions from the user to the responder and provide the directions to the user. The directions may be sent over an electronic channel such as a telecommunications network (e.g. the Internet) or the direction may be read aloud to the user if the user is interfacing with the server using a telephone or cell phone.

FIG. 5 also shows an example of possible emergency codes 520 that a user may select or that an automated system, such as a vehicles telematics system may send to the server. The listing of possible entries is provided for illustrative purposes and should not seen as limiting. The emergency codes may be based on standard medical classifications. Preferably, the emergency codes would be a reduced set of the standard medical classifications. The emergency codes would be preferably of a limited set in order to allow for quick selection on the part of a user or another person that is present at the emergency location. In some embodiments, the emergency code may require a multi-step process for selection. A user may be provided with a listing of overall classifications (e.g. body parts, accident type, symptoms) by an application residing on the user's transmission device. One of the classifications may be selected and then the application will provide the with a more refined listing of emergency codes based upon the selected classification.

In an automated telematics system within an automobile, sensors within the automobile may provide information to an application and the application will select the appropriate emergency code based upon the sensor information. For example, there may be an accelerometer sensor and a temperature sensor used for purposes of an embodiment of the present invention. The temperature sensor may indicate that the temperature is in excess of 140 degrees Fahrenheit and the accelerometer sensor may indicate that there is a sudden deceleration. The telematics program within the automobile would determine that there has been a car crash and also that there is a fire and would select the appropriate emergency codes to transmit to the server. For other communication devices, similar automated selection of codes and creation of an emergency request transmission may occur. Cellular telephones have been embedded with sensors including accelerometers, gyroscopes, and temperature sensors. Thus, a program operating on the communication device that has access to the output of the sensors may automatically select an emergency code and an emergency level based upon the sensor outputs without intervention by the user.

As indicated in previous embodiments of the invention, the user may be presented with a button or other selection mechanism that indicates that the user is suffering from a medical condition as indicated in the user's profile. Additionally, there may be a separate button to indicate an a high emergency level. Thus, these buttons may cause the automatic creation of an emergency request transmission that indicates that immediate emergency attention is required. The server may be configured to recognize that if not emergency code is provided that there is an assumption that the emergency level is high and that the nearest responder should be dispatched to the emergency location.

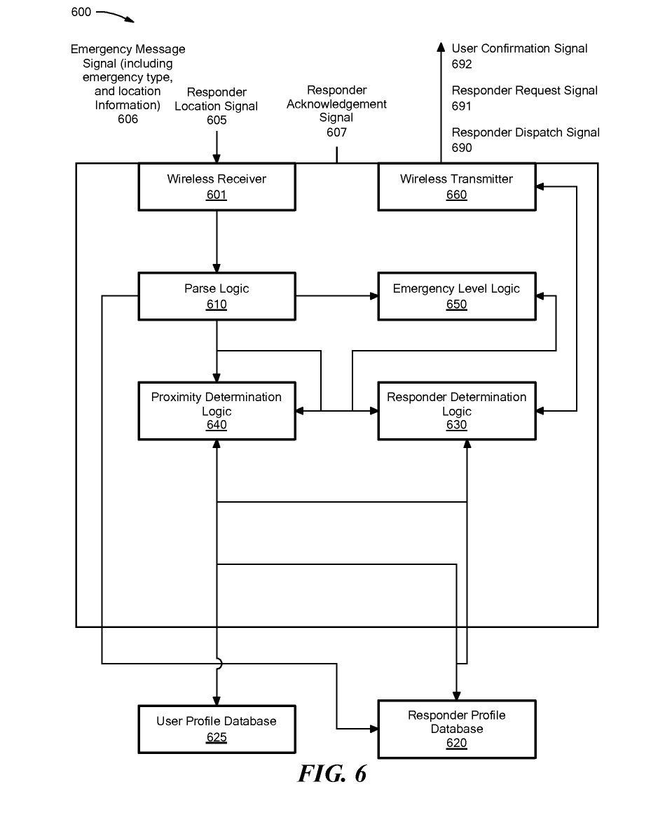

FIG. 6 shows a server side embodiment of the invention. As shown in the figure the server 600 includes a wireless receiver 501. The wireless receiver 601 receives as input transmissions from both users requesting emergency service and also from the responders. The responders periodically transmit location information 605 to the wireless receiver. It should be recognized by one of ordinary skill in the art that the wireless receiver need not be part of the server. In different embodiments, the wireless receiver may be part of a cellular telecommunications network and the wireless receiver forwards the received emergency request transmission to the server over a wire line or other transmission medium. The server includes parse logic 610. The parse logic 610 identifies the type of received transmission. The transmission that originates from the responders includes at least a responder identifier and also location information for the responder. The transmissions from the users and the responders may also include a leading indicator as to the source of the transmission (e.g. 1=user, 0=responder). The parser would identify the transmission source and then could appropriately parse the transmission according to a set transmission protocol format for either the emergency request transmission 606 or the transmission from the responder. The responder protocol may include another identifier that indicates whether the responder's transmission is a responder location signal 605 or a responder acknowledgement signal 607. The parser 610 then parses the information from the received signal and passes the information to appropriate logic or to memory. In the present application, the term logic shall refer to hardware, software embodied on a computer readable storage medium, or a combination of hardware and software stored in memory (firmware). If the parser 610 recognizes and parses a transmission from a responder and the responder transmission contains location information, the parser logic identifies the responder by the responder identifier, searches for the responder's profile in memory containing at least a portion of the responder profile database 620 and updates the field that contains the responder's current location. If the responder's information contains an acknowledgement for a particular emergency, the parser passes the acknowledgement to the responder determination logic 630. After a predetermined amount of time or after all of the requested responders have acknowledged the request, the responder determination logic 630 will access the proximity information for the requested responders. The proximity information may be temporarily stored in the proximity determination logic 640 or in associated memory. The responder determination logic 630 then generates a responder dispatch signal 690 to a selected one of the acknowledging responders. The responder determination logic 630 will at the least provide the location (address, longitude and latitude) or directions from the responder's location to that of the emergency location.

The present system may be duplicated from locale to locale such that the responder and user databases contain only local information. In other embodiments, the locale may be a city, state or country, such that if the locale is a country, one central database may be accessed for responders and users throughout the country.

The parse logic 610 if it receives an emergency request transmission will parse the user identifier, the user location, and the emergency type and pass the information to the proximity determination logic. The parse logic will also pass the emergency level, the emergency type and at least the user identifier to the emergency level logic 650. If the emergency level logic determines that the emergency level is high, the emergency level logic will have the responder determination logic 630 locate the closest responder to the emergency location. The responder determination logic 630 retrieves responder profile information 620 for the specified emergency type and passes the information to the proximity determination logic 640 for determining the responder that is closest in proximity to the emergency. Once the proximity information is passed from the proximity determination logic 640 to the responder determination logic 630, the responder determination logic 630 generates a request 691 to one or more of the proximate responders. The request 691 is then transmitted to a wireless transmitter 660 that may be part of the server 600. In other embodiments, as with the wireless receiver, the wireless transmitter may be part of the telecommunication system, such as, a cellular network and not part of the server.

Regardless of whether the emergency level is high or not, the information from the emergency request transmission is passed to the responder determination logic 630 and location information and the user identifier can be either passed to or will remain in the proximity determination logic. The responder determination logic 630 then performs a series of logical steps to determine if a specialist needs to be sent to the emergency location, how many responders should be sent to the emergency location, and the types and qualifications of the responders by retrieving and using the user profile form the user profile database 625 along with the data from the emergency request signal 606. The responder determination logic 630 searches the responder database 620 and passes responder location information for identified responders have the appropriate qualifications (emergency type, specialty, equipment, drugs/medication) to the proximity determination logic 640 to determine the closest responders to send. The responder determination logic 630 then identifies one or more responders to send and may repeatedly make requests to the proximity determination logic 640 to determine the proximity of responders until a proximity criteria is met (e.g. within a range of 1 mile, 2 miles, 10 miles, 20 miles etc.). The responder determination logic 630 will then send requests to the appropriate responders.

In certain embodiments and under certain conditions, the responder determination logic 630 may send a transmission to the user as a user confirmation signal 692. For example, if the user has indicated a low level emergency, the user will be sent a confirmation signal that contains information about the location of an appropriate responder. Thus, the user's communication device should preferably be a two way communication device. The location may include an address, longitude and latitude or directions and may be communicated as a displayable message on the user's communication device or as a data input to another linked program. For example, the longitude and latitude of the responder could be transmitted to the user's communication device and the user's communication device

The embodiments of the invention described above are intended to be merely exemplary; numerous variations and modifications will be apparent to those skilled in the art. All such variations and modifications are intended to be within the scope of the present invention as defined in any appended claims.

Although the previously discussed embodiments of the present invention have been described separately, it is to be understood that some or all of the above described features can also be combined in different ways. The discussed embodiments are not intended as limitations but serve as examples illustrating features and advantages of the invention. The embodiments of the invention described above are intended to be merely exemplary; numerous variations and modifications will be apparent to those skilled in the art. All such variations and modifications are intended to be within the scope of the present invention as defined in any appended claims.

It should be recognized by one of ordinary skill in the art that the foregoing methodology may be performed in a signal processing system that may include one or more processors for processing computer code representative of the foregoing described methodology. The computer code may be embodied on a tangible computer readable storage medium i.e. a computer program product.

The present invention may be embodied in many different forms, including, but in no way limited to, computer program code for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, the methodology may be implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

What is claimed is:

1. A method for identification of a responder for responding to an emergency, the method comprising:
receiving at a server user data including an emergency type, user identity, and location of the emergency;
retrieving from a database a user profile based on the user identity;
searching a responder profile database that includes real-time location information to identify a responder to dispatch to the emergency based upon a criteria set including the determined specialization necessary, the availability of the responder as indicated in the responder profile, and the proximity of the responder to the location of the emergency;
electronically contacting one or more responders that meet the criteria set;
receiving at the server an acceptance from one or more of the responders; and
dispatching to the location of the emergency one or more of the accepting responders.

2. The method according to claim 1, further comprising:
determining if a specialized responder is required based at least upon the user profile.

3. The method according to claim 1, wherein the transmission includes an emergency code and wherein determining if a specialized responder is required is also based upon the emergency code.

4. The method according to claim 1, wherein the received emergency type causes the server to restrict the responder database to responders of the emergency type.

5. The method according to claim 1, wherein the transmission includes an emergency level and wherein if the emergency level indicates that the level is high, the closest responder is automatically dispatched to the emergency location.

6. The method according to claim 1, wherein the transmission includes an emergency level and wherein of the emergency level is low, the user is directed to a location of the responder meeting the criteria set and wherein responders meeting the criteria set are not dispatched to the location of the emergency.

7. The method according to claim 1, wherein the user profile includes any specific medical conditions of the user, and wherein the specific medical conditions are used by the server to determine if a specialized responder is necessary to dispatch to the location of the emergency.

8. The method according to claim 7, wherein in response to the user profile, the responder database is restricted to only responder profiles having the required specialty.

9. The method according to claim 1, wherein the responder database is restricted to only responder profiles within a predetermined proximity of the emergency location.

10. The method according to claim 1, wherein the user profile includes the user's medical insurance and wherein the user's medical insurance is used in determining an appropriate responder to dispatch to the emergency location.

11. The method according to claim 1, wherein the server periodically receives a transmitted location signal from one or more of the responders listed in the responder database.

12. The method according to claim 1, wherein the transmitted location signal is generated by an electronic device containing a global positioning satellite receiver.

13. The method according to claim 1, wherein the responder's profile contains an availability schedule.

14. The method according to claim 13, wherein the availability schedule is constrained by emergency level.

15. The method according to claim 1, wherein the emergency type is indicative of either a fire emergency, a police emergency, or a medical emergency.

16. The method according to claim 1, wherein the transmission containing the location of the emergency is generated by an electronic device that includes a global positioning satellite receiver.

17. A computer program product including a computer readable storage medium having computer executable code thereon for identification of a responder from a responder database for responding to an emergency, the computer code comprising:
computer code for receiving an electronic transmission including an emergency type, user identity, and location of the emergency;
computer code for retrieving from a user profile database a user profile based on the user identity;
computer code for searching a responder profile database that includes real-time location information to identify a responder to dispatch to the emergency based upon a criteria set including, the availability of the responder, and the proximity of the responder to the location of the emergency;
computer code for contacting one or more responders that meet the criteria set;
computer code for receiving at the server an acceptance from one or more of the responders; and
computer code for dispatching to the location of the emergency one or more of the accepting responders.

18. The computer program product according to claim 17, further comprising:
computer code for determining if a specialized responder is required based at least upon the user profile;

19. The computer program product according to claim 17, wherein the received transmission includes an emergency code and wherein the computer code for determining if a specialized responder is required is also based upon the emergency code.

20. The computer program product according to claim 17, further comprises:
computer code for restricting the responder database to responders of the emergency type.

21. The computer program product according to claim 17, wherein the received transmission includes an emergency level and further comprising:
computer code for automatically dispatching the closest responder to the emergency location if the emergency level is high.

22. The computer program product according to claim 17, wherein the received transmission includes an emergency level and further comprises computer code for directing the user to a location of a responder meeting the criteria set if the emergency level is low and computer code preventing execution of the computer code for dispatching one or more responders to the location of the emergency.

23. The computer program product according to claim 17, wherein the user profile includes any specific medical conditions of the user and wherein the computer code for determining if a specialized responder is necessary to dispatch to the location of the emergency is based at least in part upon any specific medical conditions of the user.

24. The computer program product according to claim 23, further comprising computer code for restricting the responder database to only responder profiles having the required specialty.

25. The computer program product according to claim 17, further comprising computer code for restricting the responder database to responder profiles within a predetermined proximity of the emergency location.

26. The computer program product according to claim 17, wherein the user profile includes a user's medical insurance and the computer code for determining an appropriate responder to dispatch is based in part upon the user's medical insurance and whether the responder accepts the user's medical insurance.

27. The computer program according to claim 17, further comprising computer code for periodically receiving a transmitted location signal from one or more of the responders listed in the responder database.

28. The computer program product according to claim 17, wherein the responder's profile contains an availability schedule.

29. The computer program product according to claim 28, wherein the availability schedule is constrained by emergency level.

30. The computer program product according to claim 17, wherein the emergency type is indicative of either a fire emergency, a police emergency, or a medical emergency.

31. A system for determining an appropriate responder to dispatch to an emergency location, the system comprising:
a user profile database containing user profiles identifying each user;
a responder profile database containing responder profiles at least identifying each responder, the specialty of the responder, and a current location of the responder;
a decision engine including at least one processor for receiving an emergency request signal from a user wherein the emergency request signal includes indicia of user identity, user location, and emergency type and wherein the decision engine selects one or more responders to dispatch to the user location based upon the emergency type and the responder's proximity to the user.

32. A system according to claim 31 wherein the user's profile indicates any special medical condition of the user and the decision engine also selects one or more responders to dispatch to the user location based in part on the specialty of the responder and the special medical condition listed in the user profile.
